(19) United States
(12) Patent Application Publication
(10) Pub. No.: US 2026/0086756 A1
(43) Pub. Date: Mar. 26, 2026

(54) INPUT AREAS BASED UPON OPERATING MODE OF DEVICE

(71) Applicant: Lenovo (United States) Inc., Morrisville, NC (US)

(72) Inventors: Robert J. Kapinos, Durham, NC (US); Robert James Norton, JR., Raleigh, NC (US); Scott Li, Cary, NC (US); Igor Stolbikov, Apex, NC (US)

(21) Appl. No.: 18/891,875

(22) Filed: Sep. 20, 2024

(51) Int. Cl. G06F 3/14

(52) U.S. Cl. CPC G06F 3/1423

(57) ABSTRACT

One embodiment provides a device, including: identifying, utilizing an input establishment system, a form factor of an information handling device comprising a plurality of displays and being convertible into more than one form factor; determining, based upon at least the form factor identified, an operating mode for the information handling device; and establishing, utilizing the input establishment system and based upon the operating mode, one or more input areas on the information handling device. Other aspects are claimed and described.

### BACKGROUND

Receipt of input at an information handling device has developed from a single method to a variety of input methods. What was once strictly a manual input using a peripheral device (e.g., a mouse, keyboard, etc.) has transitioned into the acceptance of audible, visual, touch, and/or the like. Even in some systems, input may be provided by tracking biometrics. Information handling devices have become powerful enough that they can support this variety of input methods and, in some cases, can accept more than one input simultaneously.

### BRIEF SUMMARY

In summary, one aspect provides a method, including: identifying, utilizing an input establishment system, a form factor of an information handling device including a plurality of displays and being convertible into more than one form factor; determining, based upon at least the form factor identified, an operating mode for the information handling device; and establishing, utilizing the input establishment system and based upon the operating mode, one or more input areas on the information handling device.

Another aspect provides a system, the system including: a processor; a memory device that stores instructions that, when executed by the processor, causes the system to: identify, utilizing an input establishment system, a form factor of an information handling device including a plurality of displays and being convertible into more than one form factor; determine, based upon at least the form factor identified, an operating mode from the information handling device; and establish, utilizing the input establishment system and based upon the operating mode, one or more input areas on the information handling device.

A further aspect provides a product, the product including: a computer-readable storage device that stores executable code that, when execute by a processor, causes the product to: identify, utilizing an input establishment system, a form factor of an information handling device including a plurality of displays and being convertible into more than one form factor; determine, based upon at least the form factor identified, an operating mode for the information handling device; and establishing, utilizing the input establishment system and based upon the operating mode, one or more input areas on the information handling device.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method for establishing one or more input areas on an information handling device by use of an input establishment system.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

An acceptable user input at a device is based upon multiple factors, for example, input mechanisms associated with a device, the power of an operating system present within a device, an orientation of a device, and/or the like. Input mechanisms, for example, peripheral devices may permit a user to provide input a device using a more traditional method such as using a mouse and/or keyboard for selection. As devices evolved and users started using them for different tasks, the input types or modalities also changed. For example, input types such as audible and/or visual input methods started to become more widely available for devices. Operating systems implemented into a device will now come with standard voice and/or gaze recognition software and the associated hardware components. For example, a device will commonly include a microphone that allows for the acceptance of audible input.

An orientation of a device can further influence acceptable inputs. In combination with the power of an operating system and the presence of peripheral devices, integral components, and/or the removal of either, how a device is orientated can identify how a user is attempting to use the device and how the user wants to provide input to the device. For example, a tablet device may not include a peripheral device, but may instead accept touch input directly on a display of the device. Such a device does not require a peripheral device for accepting input. Some devices can be converted from one form factor to another form factor. Such devices, commonly referred to as convertible devices, may allow a user to use it as a tablet, in a stand mode, as a laptop, and/or the like. For example, one convertible device may include a hinge that permits the device to be used in a standard laptop form factor or orientation or in a tablet form factor or orientation. Such a device may accept input in a variety a ways dependent on the orientation of the device while in use. Multi-orientation devices are growing in popularity for many reasons, for example, to condense the size of a device, reduce a number of separate devices needed, increase the portability of the device, increase the usability of the device for multiple uses, and/or the like.

Modern devices, both single orientation and multi-orientation devices, can accept inputs simultaneously. A user in operation of a device can supply inputs in more than one way at the same instance. For example, a user that is present on a video-conferencing call can supply video input of a user attending a call, supply audible input when speaking during the video-conference, and can operate a device in a traditional manner by providing input at a peripheral device, all at the same time. Operating systems can support multiple inputs at a device while in operation. However, even with an ability to receive multiple inputs at the same time, a device can only process the inputs in a single user interface. For example, input provided will only be used in a single input area or active application on a single input area. As an example, a user that is on a conference call that is accepting audio input by use of a microphone cannot simultaneously provide audio input to perform song recognition.

In some current devices, a device may allow multi-user use cases permitting two users to utilize the same device. However, this is done by duplicating a input area across two different displays. Since the operating system restricts what can be inputted into a system and how it is inputted, the input provided from one user will influence the input area and applications of another user. In other words, the system input area can only accept one queue of inputs and users must alternate input actions. Thus, while both users can see the same thing and can provide inputs, the users are unable to work independently from each other. Therefore, what is needed is a system that can establish multiple input areas and queues that may act independently from each other a single device. In other words, depending on how the user or users are utilizing the device, the system could process inputs associated with different displays of the device either independently from other or synchronously depending on the form factor and operating mode of the device.

Accordingly, the described system and provides a method for establishing one or more input areas and input queues on an information handling device by use of an input establishment system. The input establishment system present on a device may identify a form factor of an information handling device. The form factor identifies how the device is physically configured. For example, the form factor may be a stand form factor, a laptop form factor, a tablet form factor, a tent form factor, a double-sided flat form factor, and/or the like. The input establishment system may determine an operating mode for the information handling device based upon at least the identified form factor. An operating mode of a device may be associated with how the information handling device is currently being used by one or more users. For example, the operating mode may identify if a single user is utilizing the device, if more than one user is utilizing the device, how many separate displays the user is attempting to utilize on the device, whether the user is attempting to use more than one display as a single display, and/or the like. The operating mode may change as the form factor of a device changes.

Based upon the determined operating mode of the information handling device and utilizing the input establishment system, the system and method may establish one or more input areas on the information handling device. These one or more input areas established on a single information handling device may operate independently from one another depending on the operating mode. For example, if more than one user is utilizing the device and want the displays to be operated independently, the inputs areas may be established as independent input areas. In each independent area, input constructs such as mouse cursor, touch keyboard, and type input cursor may be duplicated.

Similarly, attached physical control devices such as keyboard and mouse may become dedicated for each input area. On the other hand, if a single user is utilizing the device and wants the displays to be operated as a single display, the input areas may be established as synchronized input areas, meaning inputs from any of the input areas will affect how the system is operating or what is displayed. In this case, only a single input construct of each type is active, and all physical human I/O devices are directed to the same input queues. Such a system and method provide an improvement over traditional multi-input devices and/or multi-user devices by permitting the use of one or more input areas that may act independently or synchronously under an identified operating mode.

The illustrated example embodiments will be best understood by reference to the figures. The following description is intended only by way of example, and simply illustrates certain example embodiments.

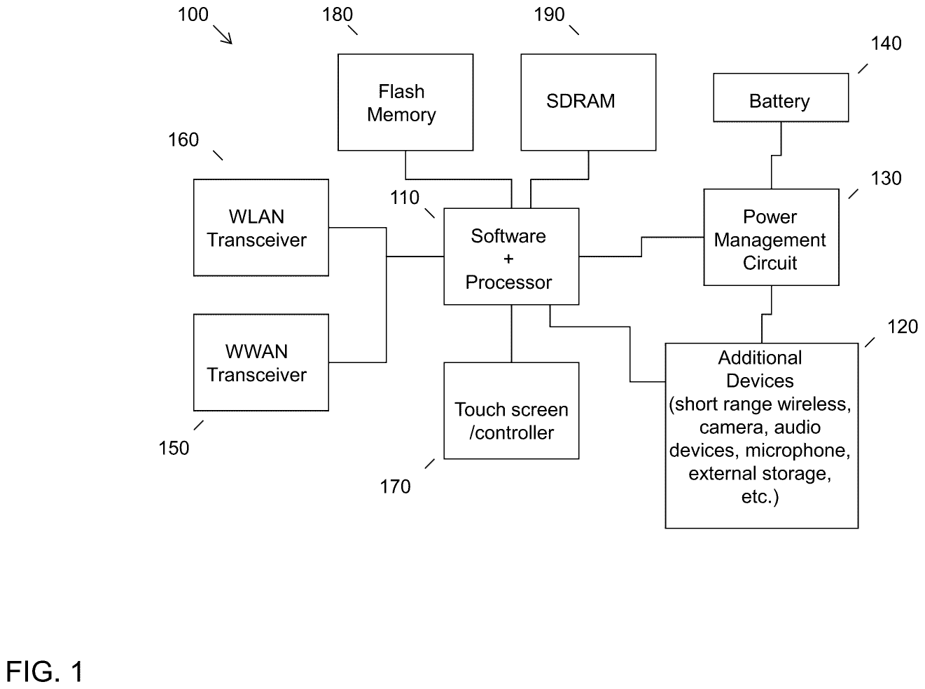

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, input/output (I/O) ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use serial advanced technology attachment (SATA) or peripheral component interconnect (PCI) or low pin count (LPC). Common interfaces, for example, include secure digital input/output (SDIO) and inter-integrated circuit (I2C).

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply basic input/output system (BIOS) like functionality and dynamic random-access memory (DRAM) memory.

System 100 typically includes one or more of a wireless wide area network (WWAN) transceiver 150 and a wireless local area network (WLAN) transceiver 160 for connecting to various networks, such as telecommunications networks and wireless Internet devices, e.g., access points. Additionally, devices 120 are commonly included, e.g., a wireless communication device, external storage, etc. System 100 often includes a touch screen 170 for data input and display/rendering. System 100 also typically includes various memory devices, for example flash memory 180 and synchronous dynamic random-access memory (SDRAM) 190.

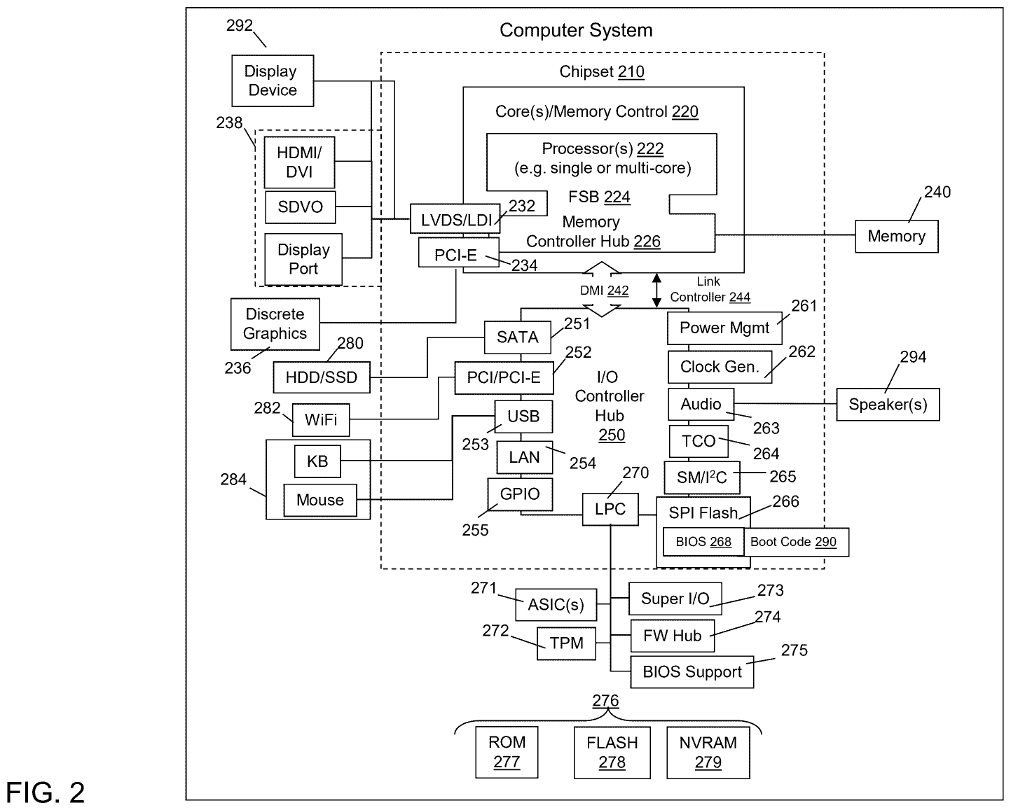

FIG. 2 depicts a block diagram of another example of information handling device circuits, circuitry, or components. The example depicted in FIG. 2 may correspond to computing systems such as personal computers, or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of random-access memory (RAM) that may be referred to as “system memory” or “memory”). The memory controller hub 226 further includes a low voltage differential signaling (LVDS) interface 232 for a display device 292 (for example, a cathode-ray tube (CRT), a flat panel, touch screen, etc.). A block 238 includes some technologies that may be supported via the low-voltage differential signaling (LVDS) interface 232 (for example, serial digital video, high-definition multimedia interface/digital visual interface (HDMI/DVI), display port). The memory controller hub 226 also includes a PCI-express interface (PCI-E) 234 that may support discrete graphics 236.

In FIG. 2, the I/O hub controller 250 includes a SATA interface 251 (for example, for hard-disc drives (HDDs), solid-state drives (SSDs), etc., 280), a PCI-E interface 252 (for example, for wireless connections 282), a universal serial bus (USB) interface 253 (for example, for devices 284 such as a digitizer, keyboard, mice, cameras, phones, microphones, storage, other connected devices, etc.), a network interface 254 (for example, local area network (LAN)), a general purpose I/O (GPIO) interface 255, a LPC interface 270 (for application-specific integrated circuit (ASICs) 271, a trusted platform module (TPM) 272, a super I/O 273, a firmware hub 274, BIOS support 275 as well as various types of memory 276 such as read-only memory (ROM) 277, Flash 278, and non-volatile RAM (NVRAM) 279), a power management interface 261, a clock generator interface 262, an audio interface 263 (for example, for speakers 294), a time controlled operations (TCO) interface 264, a system management bus interface 265, and serial peripheral interface (SPI) Flash 266, which can include BIOS 268 and boot code 290.

The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices, which may include convertible devices or other devices that can support multiple input areas that could be used independently or synchronously. For example, the circuitry outlined in FIG. 1 may be implemented in a tablet or smart phone embodiment, whereas the circuitry outlined in FIG. 2 may be implemented in a personal computer embodiment.

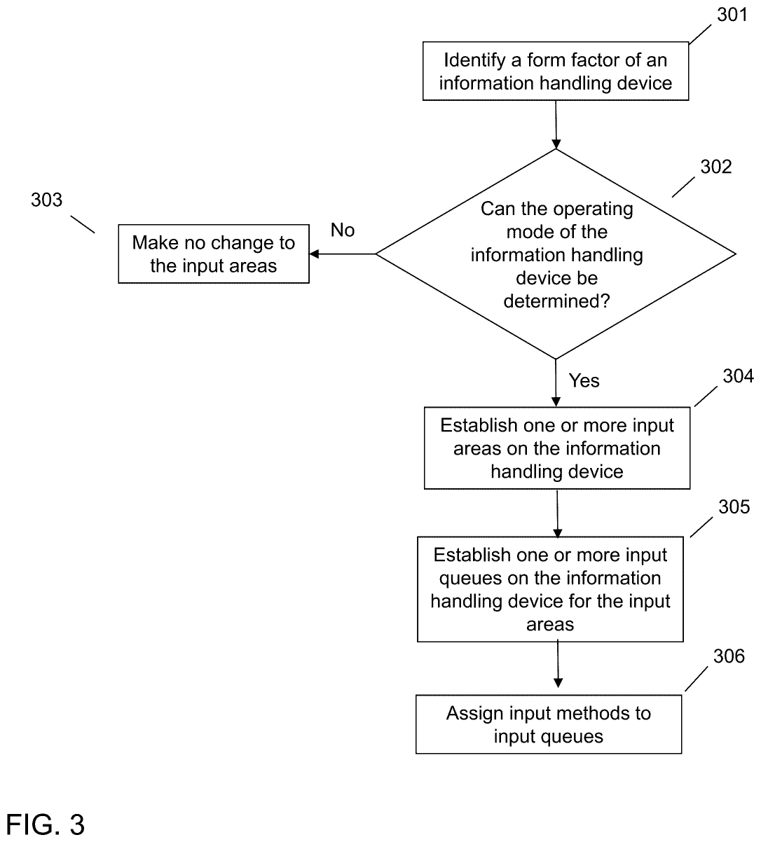

FIG. 3 illustrates an example method for establishing one or more input areas on an information handling device by use of an input establishment system. The method may be implemented on a system which includes a processor, memory device, output devices (e.g., display device, printer, etc.), input devices (e.g., keyboard, touch screen, mouse, microphones, sensors, biometric scanners, etc.), image capture devices, and/or other components, for example, those discussed in connection with FIG. 1 and/or FIG. 2. While the system may include known hardware and software components and/or hardware and software components developed in the future, the system itself is specifically programmed to perform the functions as described herein to establish one or more input areas on an information handling device based upon an identified form factor of the information handling device in use and a determined operating mode associated with the identified form factor. Additionally, the input establishment system includes modules and features that are unique to the described system.

The input establishment system may be a standalone system, may be accessible through other computing devices, and/or a combination thereof. For example, the input establishment system may be a standalone system accessed by a user and/or may be provided as an application that is accessible by a user on a computing device. The input establishment system may be accessible using any type of computing device, for example, a personal computer, laptop computer, smartphone, tablet, smartwatch, smart television, or other smart appliance, augmented reality device, virtual reality device, and/or the like. Thus, the input establishment system may be accessible locally using a computing device where the input establishment system is installed and/or may be accessible remotely through another computing device. However, the input establishment system may be located and operated on an information handling device to perform the described steps.

The input establishment system may utilize one or more artificial intelligence models in determining an identified form factor of an information handling device and determining an associated operating mode with the identified form factor. Artificial intelligence models may also be used for steps within a step. For example, a model could be utilized to receive sensors inputs regarding the configuration of the device and then recognize a form factor of an information handling device based upon the sensor inputs. As another example, a model could be utilized to receive inputs regarding a location or position of one or more users with respect to a device, identify inputs related to how a user or users are utilizing the device, and/or the like to determine an operating mode of the device. For ease of readability, the majority of the description will refer to a single artificial intelligence model. However, it should be noted that an ensemble of artificial intelligence models or multiple artificial intelligence models may be utilized. Additionally, the term artificial intelligence model within this application encompasses neural networks, machine-learning models, deep learning models, artificial intelligence models or systems, and/or any other type of computer learning algorithm or artificial intelligence model that may be currently utilized or created in the future.

The artificial intelligence model may be a pre-trained model that is fine-tuned for the input establishment system or may be a model that is created from scratch. Since the input establishment system is used in conjunction with identifying a form factor and operating mode of a device to establish input areas, some models that may be utilized by the system are audio analysis models, transcript models, image analysis models, sensor input analysis models, entity identification models, similarity identification models, analysis models, filtering models, classification models, language models, large language models, and/or the like. The model may be trained using one or more training datasets. Additionally, as the model is deployed, it may receive feedback to become more accurate over time. The feedback may be automatically ingested by the model as it is deployed. For example, as the model is used to identify a form factor of an information handling device and determine an associated operating mode to establish one or more input areas, and a user provides input that the operating mode or input area establishment was incorrect or otherwise modifies the operating mode or input areas, the model ingests this feedback to refine the model.

On the other hand, and for example, as the model identifies the form factor and associated operating mode and establishes input areas, and no changes are made to the operating mode and/or input areas, the model may utilize this as feedback to further refine the model. This may be referred to as reinforcement training where a prediction that was made by the model is reinforced as the correct prediction. Training the model may be performed in one of any number of ways including, but not limited to, supervised learning, unsupervised learning, semi-supervised learning, training/validation/testing learning, and/or the like.

As previously mentioned, an ensemble of models or multiple models may also be utilized. Some example models that may be utilized are variational autoencoders, generative adversarial networks, recurrent neural network, convolutional neural network, deep neural network, autoencoders, random forest, decision tree, gradient boosting machine, extreme gradient boosting, multimodal machine learning, unsupervised learning models, deep learning models, transformer models, inference models, and/or the like, including models that may be developed in the future. The chosen model structure may be dependent on the particular task that will be performed with that model.

The input establishment system may include different components for carrying out different functions of the system, including different steps to be performed. These components may be hardware components or software components. Some hardware components may include sensors (e.g., biometric sensors, image capture devices, proximity sensors, microphones, accelerometers, activity trackers, health metric sensors, etc.) that can be used to identify a form factor of an information handling device, identify user input types, determine an operating mode, and/or the like. Other input devices may be utilized to assist with identifying the form factor of an information handling device, determining an operating mode, and/or the like, for example, mechanical input modalities (e.g., keyboard, mouse, etc.), touch input devices, gesture input devices, electromyography input devices, audio input devices, and/or the like. Other hardware components may be utilized to provide output from the input establishing system.

One software component may include a user profile which may be unique to a user and may assist in determining an operating mode for the information handling device. For example, the user profile may identify that when the device is in a particular form factor, the operating mode will be a particular operating mode. The user may manually input this data into the profile or the information may be populated by the system as the system learns about the user over time. For example, the system may utilize an artificial intelligence model to learn about the user, make correlations between information received from sensors and other inputs and operating modes of the device, and/or the like. This information can be populated within the user profile for use by the system during subsequent operating mode determinations. The user profile may also include other information about the user that seems to influence an operating mode, for example, a location of use of a device and associated operating modes, an environment the user is within when using a device and associated operating modes, other people in proximity to a user when using a device and associated operating modes, and/or the like. A user profile could also designate which physically attached input devices bind to each independent input area in each form factor.

At 301, the system may identify a form factor of an information handling device. A form factor is an orientation and configuration of a device. Each information handling device has at least one form factor. For example, a traditional laptop will have a laptop form factor, a traditional computing system will have a input area form factor, and/or the like. Some devices may have more than one form factor. For example, a tablet could be utilized in a tablet form factor where the user is holding the device in one hand and providing inputs with the other hand, in a display form factor where the device is held upright by a stand and the user watches the device and may provide inputs using audio and/or gesture inputs, in a drawing form factor where the device may be laid on a horizontal surface and the user provides input using one or more hands, and/or the like.

Other devices may be convertible from one form factor to another, for example, some convertible device form factors may include stand form factor, a laptop form factor, a tablet form factor, a tent form factor, a double-sided flat form factor, and/or the like. Some devices may include multiple displays and/or multiple input devices. Thus, the form factor may identify how the displays are configured with respect to each other (e.g., back-to-back, side-by-side, angled with respect to each other, one display on each side of an easel, etc.) and how the input devices are configured with respect to each other (e.g., accessible on the same side of the device, accessible on opposite sides of the device, etc.) and the display(s) (e.g., covered by the display, uncovered by the display, on an opposite side of the display, etc.). Thus, identifying the form factor may include identifying if multiple displays could be unified as a single display based on the configuration, identifying if multiple displays are configured such that the displays could not be unified, identifying if multiple displays are positioned such that multiple people could use the device concurrently, and/or the like.

Thus, the form factor may identify how displays could be utilized with respect to each other and may identify how input devices could be utilized with respect to each other and the display(s). For example, a computing device including two or more displays may support a form factor that permits the displays to act as one large display across the multiple displays and/or may permit each display to operate individually from each other even though the displays are next to each other. As another example, a 2-in-1 laptop may include a first form factor that is orientated in a traditional laptop setup having a clamshell-shape and opening about a hinge, while also supporting a form factor that may rotate a display of the information handling device 180 degrees and allow the device to act as a tablet with the display covering the keyboard. Thus, in the first form factor a keyboard and integrated mechanical mouse input area may be accessible, but in the tablet form factor the keyboard and integrated mechanical mouse input area are not accessible.

When identifying a form factor of an information handling device at 301, the input establishment system may receive data identifying a configuration of the information handling device. The system may analyze the data to identify the configuration of the information handling device and, therefore, the form factor. Alternatively, or additionally, the device can identify the configuration of the device from data and then provide the configuration identification to the input establishment system. The input establishment system can then identify the form factor from the configuration identification. For example, and continuing an example mentioned above, when transitioning between configurations in a 2-in-1 device, data may be received at an operating system of the device at a point, for example, a threshold level of an angle of the display, that may transition a device from a traditional laptop setup up to a tablet setup, and vice versa.

The information that may be utilized to identify the form factor may include, but is not limited to, information received from sensors of the device, information received from other devices (e.g., image capture devices within an environment, audio devices within an environment, sensors within the environment, etc.), and/or the like. Some sensors may include gyroscopes, accelerometers, proximity sensors, electromagnetic sensors, switches, image capture devices, light capture devices, audio capture devices, position sensors, and/or the like. Accordingly, the information may include any information that can be received from such sensors. For example, convertible devices include sensors that detect when the device is in a particular configuration and physical orientation. Thus, these sensors can provide the information related to the configuration, or the device may simply provide an identification of the configuration to the system.

Other information that can be utilized to identify a form factor may include information related to the device itself and what is supported by the device. For example, if a device can support multiple configurations or form factors, this information can be utilized to identify possible form factors for the device. If a device is unable to be used in a particular form factor, then the system can determine that the form factor could not be that form factor. As another example, the information may include information related to a number of displays present on or connected to an information handling device. A device that includes a plurality of displays may permit a variety of form factors with respect to a number of displays present. Additionally, or alternatively, in the system, a configuration of a form factor may be identified upon the connection of an additional component, for example, an additional display, to an information handling device. For example, a device that may include a single display may operate under a single form factor, and upon the identification of an additional display to the information handling device, a form factor of the system may be permitted to change and/or adjust. For example, a convertible system may have a stationary multiple display and multiple keyboard configuration, while containing a tablet portion that freely detaches to operate singly.

After identifying a form factor, or an orientation or configuration, of an information handling device at 301, the input establishment system may determine the operating mode of the information handling device at 302. The operating mode may identify how a device is being used by one or more users. In other words, the operating mode identifies how the user, or users, are utilizing the device and how the displays should be treated for purposes of establishing input areas. For example, the operating mode may identify whether multiple displays of the device are being utilized in combination to be a single display, that the multiple displays, or a subset of the multiple displays should be treated as independent displays, and/or that the multiple displays should be treated as duplicates of one of the displays. Thus, determining an operating mode includes identify how the user, or users, is using the device.

The form factor at least partially identifies the operating mode of the device. Form factors that do not support certain operating modes would identify that the device is not be utilized in that operating mode. For example, a convertible device being used in a double-sided form factor would eliminate an operating mode where the displays are treated as a single large display. Similarly, a form factor that would support a certain operating mode would identify that the device could be utilized in that operating mode. Thus, when determining an operating mode for an information handling device 302, the input establishment system may utilize one or more parts of the received information identifying the form factor.

Determining an operating mode associated with a form factor of an information handling device 302 may include identifying a location of one or more users with respect to the information handling device. The input establishing system may trace a location of at least one user with respect to one or more areas of the device. For example, the system may identify a location or position of a user with respect to a display of the device, which may assist in establishing whether one or more users are utilizing the device and how the one or more users might be utilizing the device. The input establishment system may use one or more location identifying techniques and/or information received from a sensor coupled to the information handling device or otherwise accessible by the system (e.g., image detection, audio detection, display orientation, proximity sensors, accelerometers, heat signature detection, gyroscopes, light sensors, etc.) to determine a location and/or position of the user with respect to the device.

Thus, when determining an operating mode for the device, the system may identify a single user is utilizing the device, two users are utilizing the device, more than two users are utilizing the device, and/or the like. The number of users utilizing the device can be determined based upon the location and/or position of the user(s) with respect to the device. Additionally, when determining an operating mode for the device, the system can determine how the user is attempting to utilize the device. Specifically, the system may determine whether the user(s) is attempting to use the device as a cohesive unit or as separate independent devices. This determination may be based upon how the user is attempting to use one or more displays of the device and one or more input devices of the device. The determination may be triggered by multiple users attempting to do simultaneous input in different regions. The determination may be triggered by detection of users contending for input constructs such as mouse cursor or keyboard input cursor.

Thus, the system determines if the user is utilizing the multiple displays as a single unified display, as independent displays, or as duplicated displays. Single unified displays are multiple displays that are treated as a single display where information can be contained across the displays. In this case, there is a single input area and input queue that are spread across the displays. A single set of input constructs such as mouse cursor, touch keyboard, and type input cursor appear. Independent displays are displays that operate independently from other of the displays, meaning information contained on the display may be different than information contained on other displays. Additionally, inputs provided in association with a particular display would only affect that display. This means that each of the displays has a separate input area and input queue. The input constructs such as mouse cursor, touch keyboard, and type input cursor are duplicated for each input area. Duplicated displays are displays that show the same information on each of the displays. In this case, inputs provided in associated with one of the displays will be duplicated on other of the displays. Each of the displays has a separate input area and may have separate physical input controls, but the input queue and input constructs are the same for each of the displays, thus acting as a single input area.

To determine how the user is attempting to utilize the device, the system may access the user profile to identify a particular operating mode based upon gathered information. Additionally, or alternatively, the system may monitor movements or actions of the user to identify the user is attempting to perform certain tasks or functions that would be indicative of a particular operating mode. For example, if the user indicates that the displays should be duplicated, the system can use information to identify the operating mode. As another example, if more than one user is utilizing a device, the system may detect that the users have discussed that they would like the displays to be treated independently. As a final non-limiting example, if a single user is utilizing a device and keeps attempting a particular action that would be indicative of the user wanting two independent displays, the system may determine that the displays should be independent from each other.

If the operating mode cannot be determined at 302, the system may make no changes to the input areas at 303. In other words, if the system cannot determine an operating mode, the system may present the input areas based upon default settings associated with the form factor, the device settings, and/or the like. The default settings may include only presenting input areas that are directed to a single input queue. In other words, the system will not present input areas that could allow a user or users to utilize different portions of the device (e.g., different displays, different display areas, different input devices, etc.) as independent portions. Thus, all inputs received will be transmitted to a single input queue, regardless of whether the device includes duplicated input areas, extended input areas, a single unified input area, and/or the like.

On the other hand, if the operating mode can be determined at 302, the system, at 304, may establish one or more input areas on the information handling device. The input areas that are established establish whether the system will operate different areas of the device as independent areas. In other words, the system sets whether inputs received from different input areas are transmitted to a single queue or are transmitted to different input queues that operate independently from each other. At 305, the input queues required for each input area are created and assigned to the input areas. At 306 each input queue is assigned one or more input methods. Input methods may be physical input devices such as keyboard or touch screens. Input methods may also be onscreen constructs such as mouse cursors or keyboard cursors. Establishing the one or more input areas, input queues, is based upon the form factor and the operating mode of the device. Assigning input methods is based on the form factors, the available methods, and the operating mode of the device. For example, in one form factor a physically attached keyboard might be assigned to the main screen input area, and in another form factor the attached keyboard might be hidden, so an onscreen keyboard is constructed and assigned to the main screen input area. The system identifies whether the form factor allows for one or more users to utilize different portions of the device as separate independent areas or whether the form factor only allows for use of the device as a single device. For example, the system identifies whether multiple displays could be utilized as separate displays or only one display could be utilized. As another example, the system identified whether multiple input devices could be utilized as separate devices or the input devices can only be used as unified devices.

Additionally, the operating mode is utilized to identify how the user or users are attempting to utilize the device. For example, the operating mode can be used to determine if the user or users intend to use different portions of the device as separate, independent portions or as unified portions. In other words, the system determines from the form factor and the operating mode whether the device can be split into portions so that inputs to different input areas can be transmitted to separate, independent input queue, thereby allowing control of the input areas independently without affecting the other user or whether the device should be treated as a single unified system where inputs that are provided to input areas are transmitted to a single input queue, thereby causing all inputs to control the same input area.

For example, the information handling device may include more than one display, and upon identifying the presence of more than one user at the information handling device, the system may establish independent input areas at each display of the information handling device. Each input area is established with its own mouse cursor, touch area, keyboard cursor, onscreen keyboard, or other input construct necessary to provide input separate from other input areas. Inputs provided to these independent input constructs would only be transmitted to the corresponding input queue without affecting other input queues or input areas. Thus, each of the displays would operate independent from each of the other displays. While two displays are used as an example, this is only for illustrative purposes as more displays may be utilized. Additionally, in the case of more than two displays, the system may establish a combination of independent and unified input areas. For example, in a system with three displays, two displays may be treated as unified displays and one display may be treated as independent from the other two displays. As can be readily understood, any number of combinations of input areas and displays are possible, particularly as the number of displays increases. Thus, regardless of the number of input areas, whether one or more, inputs at each of the input areas are transmitted to an input queue associated with a given of the plurality of displays and input areas.

As another example, when the system determines that the form factor unifies the plurality of displays as a single display and the operating mode identifies a single user is utilizing the unified display as a single display, the system may establish a single set of input areas. In other words, when it is determined that single user is in operation of the system, all displays of the device may grouped together as a singular display and inputs provided to the input areas are transmitted to a single input queue and control that single input area. On the other hand, even if the form factor has the displays as a unified display, if the operating mode indicates that a single user is utilizing the device as two separate portions, the system may establish two sets of inputs areas with input constructs each set being transmitted to a separate input queue and controlling a given portion of the input area. In other words, a single user could utilize the system to have multiple independent input areas. Similarly, multiple users could utilize the system to have synchronous input areas.

Establishing a plurality of input areas is not restricted to the number of displays present at an information handling device. Rather, the input establishing system may portion a display into a plurality of input areas based upon an identified form factor of the information handling device and/or an operating mode of the information handling device. Establishing one or more input areas includes establishing a location of an input area on one or more of the plurality of devices. These input areas may include a keyboard input area, a mouse input area, a gesture input area, a touch input area, and/or the like.

Depending on the number of input areas established, the device may include multiples of the input area types and each of the input area types may operate either independently from other input area types, from other input areas of the same types, and/or the like, may operating synchronously with other input area types, with other input areas of the same types, and/or the like, or a combination thereof. In other words, a device may display two or more keyboards, two or more mouse input areas, two or more gesture input areas, and/or the like, that are considered a part of a single input area because inputs from each of the input devices is transmitted to and affects a single input queue rather than independent input areas. In other words, the number of inputs areas identifies how many independent input areas are provided, with each independent input area controlling an independent input queue. However, the number of input areas does not specifically specify the number of input devices or input device types that are provided. Thus, a single input area could include, for example, two or more onscreen keyboards that are located at different positions or locations on the device, with each of these keyboards controlling or affecting the same input queue, or one onscreen keyboard affecting each input queue, or any other combination of onscreen keyboards and input queues. Similarly, physical input device can have their input be multiplied or directed to the input queues matching any input areas.

The following paragraphs include example situations for establishing one or more input areas on an information handling device based upon an identified form factor of a device and an operating mode of the device. These examples are used for illustrative purposes and are intended to be non-limiting.

As a first example, the input establishing system may identify an information handling device having a form factor that includes two displays. The form factor may permit the displays to be facing opposite directions. The input establishment system may determine that two users are present at the information handling device, one at each display. The operating mode may be determined that the users are attempting to utilize the displays as separate, independent displays. Thus, the system may establish two input areas of the information handling device, one input area per display. Therefore, as each of the two users interact with the display orientated towards them, the displays will operate as independent input areas though they are associated with a single information handling device. Accordingly, inputs provided by each user at each display will control a input area associated with that display and will not affect the other input area of the other display.

As a second example, the input establishment system may identify an information handling device having a form factor that includes one display. The form factor may orientate the one display towards a user. The input establishment system may determine that a single user is present at the information handling device, and the operating mode is that the single user is attempting to utilize different portions of the display as separate, independent portions. Thus, the input establishment system may establish two input areas at different portions of the single display of the information handling device. Therefore, the two input areas present at the single display of the information handling device may operate as independent input areas even though they are present on the same display and associated with a single information handling device. Accordingly, inputs provided by the single user at the different input areas will control the input queue associated with the input area and will operate independently from the input queues or portions of the input area associated with the other input areas.

As a third example, the input establishment system may identify an information handling device having a form factor that includes two displays. The form factor may permit the displays to be facing opposite directions. The input establishment system may determine that four users are present at the information handling device and may identify the operating mode as each of the four users attempting to use a portion of one of the two displays as separate, independent portions. Thus, the input establishment may establish four independent input areas. The two displays are then portioned to include two input areas. Therefore, as each of the four users interact with the information handling device at their associated input area, the four input areas present on the two displays may operate as four independent input areas with the inputs from each of the input areas being transmitted to the input queue associated with the input area and not affecting the input area not associated with the input area receiving the input.

As a fourth and final, non-limiting example, the input establishment system may identify an information handling device having a form factor that includes two displays that are facing opposite directions. The operating mode may be determined to be that the users are working together and want inputs to affect a single input area. Thus, the input establishment system may establish a single input queue that affects the single input area. In this case, it should be noted that multiple input devices or input constructs are provided. For example, each display may be provided with a keyboard. For a second example, the mouse cursor may be duplicated. However, even though the device is displaying two keyboards, this is a single input area because inputs from each of the keyboards is transmitted to and affects a single input queue rather than independent input queue. Therefore, as each of the users interact with the input devices, the inputs are transmitted to and affect a single input area.

The various embodiments present herein provide an improvement over traditional methods for establishing input areas on a single information handling device for a plurality of users. Rather than requiring the device to operate under an operating mode including unified input areas, meaning all inputs received from input areas are transmitted to a single input area, the described system and method allows the system to establish input areas and a function of the input areas based upon a form factor and operating mode of the device. Thus, if one or more users are utilizing the device in a form factor and an operating mode that indicates multiple independent input areas are requested, the system can provide these input areas that operate independently from other input areas and transmit the inputs to independent input queue.

As will be appreciated by one skilled in the art, various aspects may be embodied as a system, method, or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices, and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

1. A method, comprising:
identifying a form factor of an information handling device comprising a plurality of displays and being convertible into more than one form factor, wherein the identifying the form factor comprises receiving data at an input establishment system of the information handling device comprising configuration identification information and wherein the configuration identification information comprises relationship data between the at least one of: the plurality of displays of the information handling device, input devices of the information handling device, and input devices and each of the plurality of displays of the information handling device;
determining, based upon at least the form factor identified and utilizing the input establishment system, an operating mode for the information handling device; and
establishing, utilizing the input establishment system and based upon the operating mode, one or more input areas on the information handling device.

2. The method of claim 1, wherein the determining an operating mode comprises identifying a location of one or more users with respect to the information handling device.

3. The method of claim 2, wherein the establishing comprises providing more than one input area based upon identifying more than one user is utilizing the information handling device.

4. The method of claim 3, wherein each of the plurality of displays operate independently of each of the other of the plurality of displays.

5. The method of claim 4, wherein inputs to the one or more input areas of each of the plurality of displays are transmitted to an input queue associated with a given of the plurality of displays.

6. The method of claim 1, wherein the establishing the one or more input areas comprises establishing at least one of: an input method and an input device to be assigned to each of the one or more input areas.

7. The method of claim 1, wherein the determining the operating mode comprises identifying one or more users are operating the information handling device in a mode consistent with the one or more input areas on the information handling device; and
wherein the establishing comprises establishing a plurality of input areas on one of the plurality of displays based upon the display operating as multiple input areas.

8. The method of claim 1, wherein the determining an operating mode comprises identifying a single user is utilizing each of the plurality of displays of the information handling device as independent displays; and
wherein the establishing comprises establishing input areas based upon the information handling device being utilized as separate displays.

9. The method of claim 1, wherein the establishing the one or more input areas comprises establishing a location of an input area on one or more of the plurality of displays, wherein the input area comprises at least one input method selected from the group consisting of: a physical input device, a keyboard input area, a mouse input area, a gesture input area, and a touch input area.

10. The method of claim 1, wherein the identifying comprises receiving data identifying a configuration of the information handling device.

11. A system, the system comprising:
a processor;
a memory device that stores instructions that, when executed by the processor, causes the system to:
identify a form factor of an information handling device comprising a plurality of displays and being convertible into more than one form factor, wherein to identify the form factor comprises receiving data at an input establishment system of the information handling device comprising configuration identification information and wherein the configuration identification information comprises relationship data between the at least one of: the plurality of displays of the information handling device, input devices of the information handling device, and input devices and each of the plurality of displays of the information handling device;
determine, based upon at least the form factor identified and utilizing the input establishment system, an operating mode from the information handling device; and
establish, utilizing the input establishment system and based upon the operating mode, one or more input areas on the information handling device.

12. The system of claim 11, wherein the determining an operating mode comprises identifying a location of one or more users with respect to the information handling device.

13. The system of claim 12, wherein the establishing comprises providing more than one input area based upon identifying more than one use is utilizing the information handling device.

14. The system of claim 13, wherein each of the plurality of displays operate independently of each of the other of the plurality of displays.

15. The system of claim 14, wherein inputs to the one or more input areas of each of the plurality of displays are transmitted to a input queue associated with a given of the plurality of displays.

16. The system of claim 11, wherein the establishing the one or more input areas comprises establishing at least one of: an input method and an input device to be assigned to each of the one or more input areas.

17. The system of claim 11, wherein the determining the operating mode comprises identifying one or more users are operating the information handling device in a mode consistent with the one or more input areas on the information handling device; and
wherein the establishing comprises establishing a plurality of input areas on one of the plurality of displays based upon the display operating as multiple input areas.

18. The system of claim 11, wherein the determining an operating mode comprises identifying a single user is utilizing each of the plurality of displays of the information handling device as independent displays; and
wherein the establishing comprises establishing input areas based upon the information handling device being utilizing as separate displays.

19. The system of claim 11, wherein the establishing one or more input areas comprises establishing a location of an input area on one or more of the plurality of displays, wherein the input area comprises at least one input method selected from the group consisting of: a physical input device, a keyboard input area, a mouse input area, a gesture input area, and a touch input area.

20. A product, the product comprising:
a computer-readable storage device that stores executable code that, when execute by a processor, causes the product to:
identify, utilizing an input establishment system, a form factor of an information handling device comprising a plurality of displays and being convertible into more than one form factor, wherein to identify the form factor comprises receiving data at the input establishment system of the information handling device comprising configuration identification information and wherein the configuration identification information comprises relationship data between the at least one of: the plurality of displays of the information handling device, input devices of the information handling device, and input devices and each of the plurality of displays of the information handling device;
determine, based upon at least the form factor identified and utilizing the input establishment system, an operating mode for the information handling device; and
establishing, utilizing the input establishment system and based upon the operating mode, one or more input areas on the information handling device.
